(19) United States
(12) Patent Application Publication
(10) Pub. No.: US 2014/0199497 A1
(43) Pub. Date: Jul. 17, 2014

(54) METHODS FOR REDUCING METAL OXIDE SURFACES TO MODIFIED METAL SURFACES

(71) Applicants: Tighe A. Spurlin, Portland, OR (US); Steven T. Mayer, Lake Oswego, OR (US); Jonathan D. Reid, Sherwood, OR (US); Artur Kolics, Dublin, CA (US); Huanfeng Zhu, West Linn, OR (US)

(72) Inventors: Tighe A. Spurlin, Portland, OR (US); Steven T. Mayer, Lake Oswego, OR (US); Jonathan D. Reid, Sherwood, OR (US); Artur Kolics, Dublin, CA (US); Huanfeng Zhu, West Linn, OR (US)

(21) Appl. No.: 13/741,151

(22) Filed: Jan. 14, 2013

(51) Int. Cl. B05D 3/10

(52) U.S. Cl. CPC B05D 3/105
USPC 427/558; 427/404; 118/697

(57) ABSTRACT

Method and apparatus for reducing metal oxide surfaces to modified metal surfaces are disclosed. Metal oxide surfaces are reduced to form a film integrated with a metal seed layer by contacting a solution with a reducing agent with the metal oxide surfaces. The solution with the reducing agent can contact the metal oxide surfaces under conditions that form an integrated film with the metal seed layer, and that reduces reoxidation from exposure the ambient environment. In some embodiments, an additive can be included with the reducing agent to form a surface protecting layer on the metal seed layer. In some embodiments, the metal is copper used in damascene copper structures.

### FIELD OF THE INVENTION

This disclosure generally relates to reducing metal oxide surfaces on metal seed layers. Certain aspects of this disclosure pertain to reducing copper oxide surfaces to a film integrated with a copper seed layer in damascene copper structures.

### BACKGROUND

Formation of metal wiring interconnects in integrated circuits (ICs) can be achieved using a damascene or dual damascene process. Typically, trenches or holes are etched into dielectric material, such as silicon dioxide, located on a substrate. The holes or trenches may be lined with one or more adhesion and/or diffusion barrier layers. Then a thin layer of metal may be deposited in the holes or trenches that can act as a seed layer for electroplated metal. Thereafter, the holes or trenches may be filled with electroplated metal.

Typically, the seed metal is copper. However, other metals such as ruthenium, palladium, iridium, rhodium, osmium, cobalt, nickel, gold, silver, and aluminum, or alloys of these metals, may also be used.

To achieve higher performance ICs, many of the features of the ICs are being fabricated with smaller feature sizes and higher densities of components. In some damascene processing, for example, copper seed layers on 2×-nm node features may be as thin as or thinner than 50 Å. Technical challenges arise with smaller feature sizes in producing metal seed layers and metal interconnects substantially free of voids or defects.

### SUMMARY

This disclosure pertains to methods of reducing metal oxides on a metal seed layer to a pure metal to form an integrated film with metal seed layer. The method can involve contacting the metal oxide with a solution containing a reducing agent under conditions that form the integrated film, and that reduces reoxidation from exposure to ambient environment. In some aspects, reoxidation can be minimized by shortening the duration of transfer, controlling the atmosphere during transfer, or using the same solution for the reducing agent as an electroless plating bath. In some aspects, an additive or metal salt can be included with the reducing agent to form a surface protecting layer on the metal seed layer.

This disclosure also pertains to apparatus such as systems or platforms containing plating modules, reducing modules, and optionally other modules associated with pretreatment. Examples of other modules include modules for spin rinse, drying, annealing, etc. The apparatus is configured to reduce metal oxides on a metal seed layer to form an integrated film with the metal seed layer. In some embodiments, the apparatus includes a controller with instructions configured to perform operations for reducing metal oxides on a metal seed layer to form an integrated film with the metal seed layer.

In some embodiments, the metal can include copper, which can be used in damascene copper structures. The reducing agent can include at least one of a boron-containing compound, such as a borane or borohydride, a nitrogen-containing compound, such as a hydrazine, and a phosphorus-containing compound, such as a hypophosphite. In some embodiments, the contact with the reducing agent can be performed in an inert atmosphere or reducing gas atmosphere. In some embodiments, the contact with the reducing agent can be performed in temperatures between about 10° C. and about 100° C. In some embodiments, the solution containing the reducing agent can be substantially free of dissolved oxygen. In some embodiments, the solution containing the reducing agent can include an organic additive, such as an accelerator. Other additives can include additives that increase the wetting potential of the surface of the metal seed layer or that increase the stability of the reducing agent. In some embodiments, the solution containing the reducing agent can include an inorganic additive, such as a metal salt. The organic additive and/or the metal salt can provide a surface protective coating or layer that reduces reoxidation of the metal seed layer.

### BRIEF DESCRIPTION OF THE DRAWINGS

FIG. 1A shows an example of a cross-sectional schematic of dielectric layers prior to a via etch in a damascene process.

FIG. 1B shows an example of a cross-sectional schematic of the dielectric layers in FIG. 1A after an etch has been performed in the damascene process.

FIG. 1C shows an example of a cross-sectional schematic of the dielectric layers in FIGS. 1A and 1B after the etched regions have been filled with metal in the damascene process.

FIG. 2 shows a exemplary floe diagram illustrating a method of plating copper on a substrate.

FIG. 3 shows an exemplary flow diagram illustrating a method of reducing oxides on a metal seed layer and plating metal on a substrate.

FIG. 4A shows an example of a cross-sectional schematic of an oxidized metal seed layer.

FIG. 4B shows an example of a cross-sectional schematic of a metal seed layer with a void due to removal of metal oxide.

FIG. 4C shows an example of a cross-sectional schematic of a metal seed layer with reduced metal oxide forming a reaction product not integrated with the metal seed layer.

FIG. 4D shows an example of a cross-sectional schematic of a metal seed layer with reduced metal oxide forming a film integrated with the metal seed layer.

FIG. 5A shows an exemplary flow diagram illustrating a method of reducing metal oxide surfaces and minimizing reoxidation during transfer to an electroplating system.

FIG. 5B shows an exemplary flow diagram illustrating a method of reducing metal oxide surfaces and minimizing reoxidation by having reducing treatment and electroless deposition occur in the same solution.

FIG. 5C shows an exemplary flow diagram illustrating a method comprising treating a surface of a metal seed layer with a reducing agent and a metal salt.

FIG. 6A shows an exemplary flow diagram illustrating a method comprising treating a surface of a metal seed layer with a reducing agent and surface protecting coating.

FIG. 6B shows an exemplary flow diagram illustrating a method comprising treating a surface of a metal seed layer with a reducing agent and accelerator molecules.

FIG. 6C shows an example of a schematic of a thiol self-assembled monolayer formed on a metal surface.

FIG. 7 shows an example of a top view schematic of an electrodeposition apparatus.

FIG. 8 shows an example of a top view schematic of an automated electrodeposition apparatus having a set of electroplating cells in a duet configuration.

FIGS. 9A and 9B show graphs illustrating the effects of pH, temperature, and exposure time of reducing agent treatment with the change in reflectivity of copper.

FIGS. 10A and 10B show graphs illustrating the effects of pH, temperature, and exposure time of reducing agent treatment with the estimated copper oxide converted to pure copper.

FIG. 11 shows scanning electron microscopy (SEM) images of optimized and marginal seed trench coupons from various treatments illustrating the presence of voids.

FIG. 12 shows a graph illustrating the percentage of large voids from the various treatments in the optimized and marginal seed trench coupons in FIG. 11.

FIG. 13 shows SEM images of optimized and marginal seed trench coupons from various treatments with sparged nitrogen illustrating the presence of voids.

FIG. 14 shows a graph illustrating the percentage of large voids from the various treatments with sparged nitrogen in the optimized and marginal seed trench coupons in FIG. 13.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting.

### Introduction

Although the present invention may be used in a variety of applications, one very useful application is the damascene or dual damascene process commonly used in the manufacture of semiconductor devices. The damascene or dual damascene processes may include metal interconnects, such as copper interconnects.

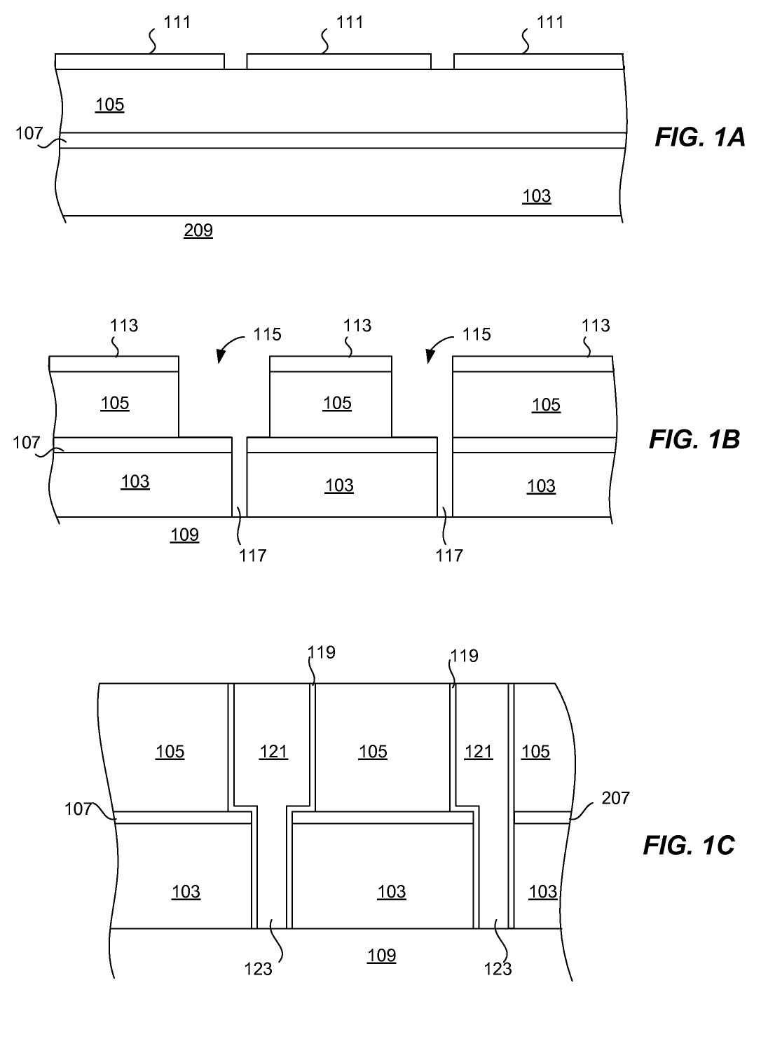

A generalized version of a dual damascene technique may be described with reference to FIGS. 1A-1C, which depicts some of the stages of the dual damascene process.

FIG. 1A shows an example of a cross-sectional schematic of one or more dielectric layers prior to a via etch in a damascene process. In a dual damascene process, first and second layers of dielectric are normally deposited in succession, possibly separated by deposition of an etch stop layer, such as a silicon nitride layer. These layers are depicted in FIG. 1A as a first dielectric layer 103, second dielectric layer 105, and etch stop layer 107. These are formed on an adjacent portion of a substrate 109, which a portion may be an underlying metallization layer or a gate electrode layer (at the device level).

After deposition of the second dielectric layer 105, the process forms a via mask 111 having openings where vias will be subsequently etched. FIG. 1B shows an example of a cross-sectional schematic of the one or more dielectric layers in FIG. 1A after an etch has been performed in the damascene process. Next, vias are partially etched down through the level of etch stop 107. Then via mask 111 is stripped off and replaced with a line mask 113 as depicted in FIG. 1B. A second etch operation is performed to remove sufficient amounts of dielectric to define line paths 115 in second dielectric layer 105. The etch operation also extends via holes 117 through first dielectric layer 103, down to contact the underlying substrate 109 as illustrated in FIG. 1B.

Thereafter, the process forms a thin layer of relatively conductive barrier layer material 119 on the exposed surfaces (including sidewalls) of dielectric layers 103 and 105. FIG. 1C shows an example of a cross-sectional schematic of the dielectric layers in FIGS. 1A and 1B after the etched regions have been coated with a conductive barrier layer material and filled with metal in the damascene process. Conductive barrier layer material 119 may be formed, for example, of tantalum nitride or titanium nitride. A chemical vapor deposition (CVD) or physical vapor deposition (PVD) operation is typically employed to deposit the conductive barrier layer material 119.

On top of the conductive barrier layer material 119, the process then deposits conductive metal 121 (typically, though not necessarily, copper) in the via holes and line paths 117 and 115. Conventionally this deposition is performed in two steps: an initial deposition of a metal seed layer followed by bulk deposition of metal by plating. However, the present disclosure provides a pre-treatment step prior to the bulk deposition step, as described in detail below. The metal seed layer may be deposited by PVD, CVD, electroless plating, or any other suitable deposition technique known in the art. Note that the bulk deposition of copper not only fills line paths 115 but, to ensure complete filling, covers all the exposed regions on top of second dielectric layer 105. The metal 121 may serve as copper interconnects for IC devices. In some embodiments, metals other than copper are used in the seed layer. Examples of such other metals include cobalt, tungsten, and ruthenium.

Metal seed layers can readily react with oxygen or water vapor in the air and oxidize from a pure metal into a mixed film of a metal oxide and a buried pure metal. While the oxidation under ambient conditions may be limited to a thin surface layer of some metals, that thin layer may represent a significant fraction or perhaps the entire thickness of thin seed layers used in current technology nodes. The relatively thin layers may be necessitated by the technology node, such as the 4× nm node, the 3× nm node, the 2× nm node, and the 1× nm node, and less than 10 nm. The height to width aspect ratio of vias and trenches in technology nodes necessitating relatively thin metal layers can be about 5:1 or greater. In such technology nodes, the thickness of the metal seed layer can be less than about 100 Å on average as a result. In some implementations, the thickness of the metal seed layer can be less than about 50 Å on average.

Through the general chemical reactions shown in Equation 1 and Equation 2 below, metals used for seed or barrier layers are converted to metal oxides (MOx), though the exact reaction mechanisms between the metal surfaces (M) and ambient oxygen or water vapor can vary depending on the properties and the oxidation state.

2M₍ₛ₎+O_{2(g)}→2MOx₍ₛ₎ Equation 1

2M₍ₛ₎+H₂O_{(g)}M₂Ox+H_{2(g)} Equation 2

For example, copper seed deposited on substrates is known to rapidly form copper oxide upon exposure to the air. A copper oxide film can form a layer that is approximately 20 Å and upwards to 50 Å thick on top of underlying copper metal. As metal seed layers become thinner and thinner, the formation of metal oxides from oxidation in ambient conditions can pose significant technical challenges.

Conversion of pure metal seed to metal oxide can lead to several problems. This is true not only in current copper damascene processing, but also for electrodeposition processes that use different conductive metals, such as ruthenium, cobalt, silver, and aluminum. First, an oxidized surface is difficult to plate on. Due to different interactions that electroplating bath additives can have on metal oxide and pure metal, non-uniform plating may result. As a result of the differences in conductivity between a metal oxide and a pure metal, non-uniform plating may further result. Second, voids may form in the metal seed that may make portions of the metal seed unavailable to support plating. The voids may form as a result of dissolution of metal oxide during exposure to corrosive plating solutions. The voids also may form on the surface due to non-uniform plating. Additionally, plating bulk metal on top of an oxidized surface can lead to adhesion or delamination problems, which can further lead to voids following subsequent processing steps, such as chemical mechanical planarization (CMP). Voids that result from etching, non-uniform plating, delamination, or other means may make the metal seed layer discontinuous, and unavailable to support plating. In fact, because modern damascene metal seed layers are relatively thin, such as about 50 Å or thinner, even a little oxidation may consume an entire layer thickness. Third, metal oxide formation may impede post-electrodeposition steps, such as capping, where the metal oxide may limit adhesion for capping layers.

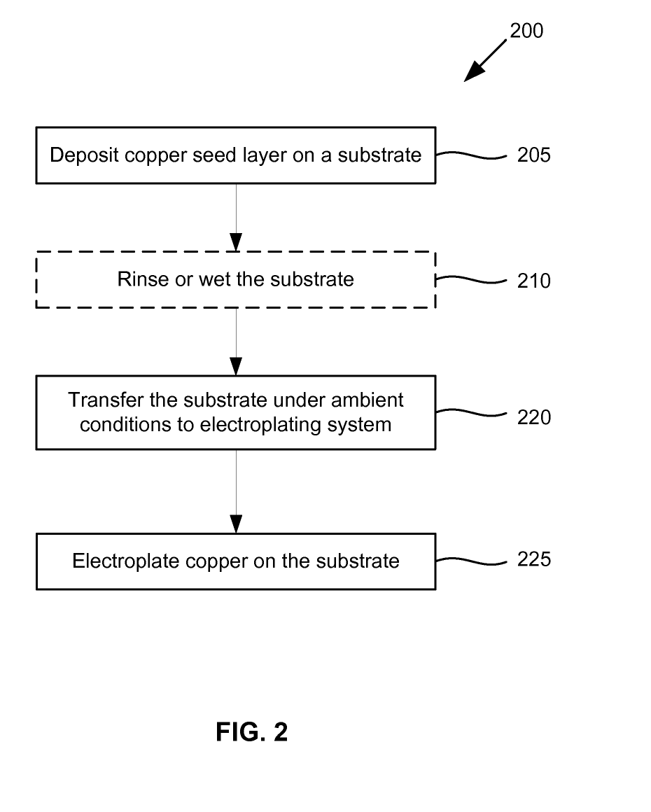

After depositing a metal seed layer but prior to plating a bulk metal on the seed layer, it may be difficult to avoid formation of metal oxide on the metal seed layer. Various steps occur prior to plating the metal that may expose the metal seed layer to oxygen or water vapor in ambient conditions. For example, FIG. 2 shows an exemplary flow diagram illustrating a method of plating copper on a substrate. The process 200 may begin at step 205, where a process chamber or deposition chamber receives a substrate such as a semiconductor wafer. A metal seed layer such as a copper seed layer may be deposited on the substrate using a suitable deposition technique such as PVD.

At optional step 210, the substrate with the metal seed layer may be rinsed and dried. For example, the metal seed layer may be rinsed with de-ionized water. The rinsing step may be limited to a time, for example, of between about 1 and 10 seconds, but may take a longer or shorter time. Subsequently, the substrate may be dried, which can be between about 20 and 40 seconds, though the drying step may take a longer or shorter time. During this step, the metal seed layer may be exposed to oxidation.

At step 215, the substrate with the metal seed layer is transferred to the electroplating system or bath. During this transfer, the metal seed layer may be exposed to ambient conditions such that the metal seed layer may rapidly oxidize. In some embodiments, the duration of this exposure may be anywhere between about 1 minute and about 4 hours, between about 15 minutes and about 1 hour, or more. At step 220, bulk metal may be electroplated on the substrate. A substrate with a copper seed layer, for example, may be immersed in an electroplating bath containing positive ions of copper and associated anions in an acid solution.

Step 220 of FIG. 2 can involve a series of processes that is described in U.S. Pat. No. 6,793,796, filed Feb. 28, 2001 (attorney docket no. NOVLP073), the entirety of which is hereby incorporated by reference. The reference described at least four phases of the electrofilling process and disclosed controlled current density methods for each phase for optimal filling of relatively small embedded features.

With various steps that may expose the metal seed layer to oxidation between deposition of the metal seed layer and electroplating, a technique for reducing the negative effects of the metal oxide surfaces is needed. However, some of the current techniques may have drawbacks. The use of hydrogen-based plasmas may reduce thick metal oxides, but such techniques add substantial costs and utilize substantially high temperatures (e.g., at least over 200° C.) that can badly damage a thin metal seed layer resulting in high void counts within features. A thermal forming gas anneal to reduce thick metal oxides uses a forming gas (e.g., mixture of hydrogen and nitrogen gas) at temperatures higher than 150° C., which can cause metal seed to agglomerate and also lead to increased voiding. The use of acids or other chemical reagents may dissolve or etch thick metal oxides, but removal of such oxides result in increased void formation in areas where metal cannot be plated onto.

The present disclosure provides methods for reducing metal oxide surfaces to modified metal surfaces. The method of reducing the metal oxide surfaces provides a substantially clean metallic surface that is substantially free of oxide when a substrate is introduced into the electroplating bath. In addition, the method of reducing the metal oxide operates in relatively low temperatures, and the reduced metal oxide converts to metal to form a continuous film that is integrated with the metal seed layer and adherent to the underlying seed or substrate.

### Process

A method of preparing a substrate with a metal seed layer for plating is disclosed. The method includes receiving a substrate having the metal seed laying on a plating surface of the substrate, where a portion of the seed layer has been converted to an oxide of the metal. The substrate has recesses having a height to width aspect ratios of greater than about 5:1. The method further includes contacting at least the oxide of the metal with a solution containing a reducing agent under conditions that reduce the oxide of the metal to the metal in the form of a film integrated with the seed layer. The method further includes transferring the substrate to a plating bath containing a plating solution, and plating metal onto the metal seed layer using the plating solution.

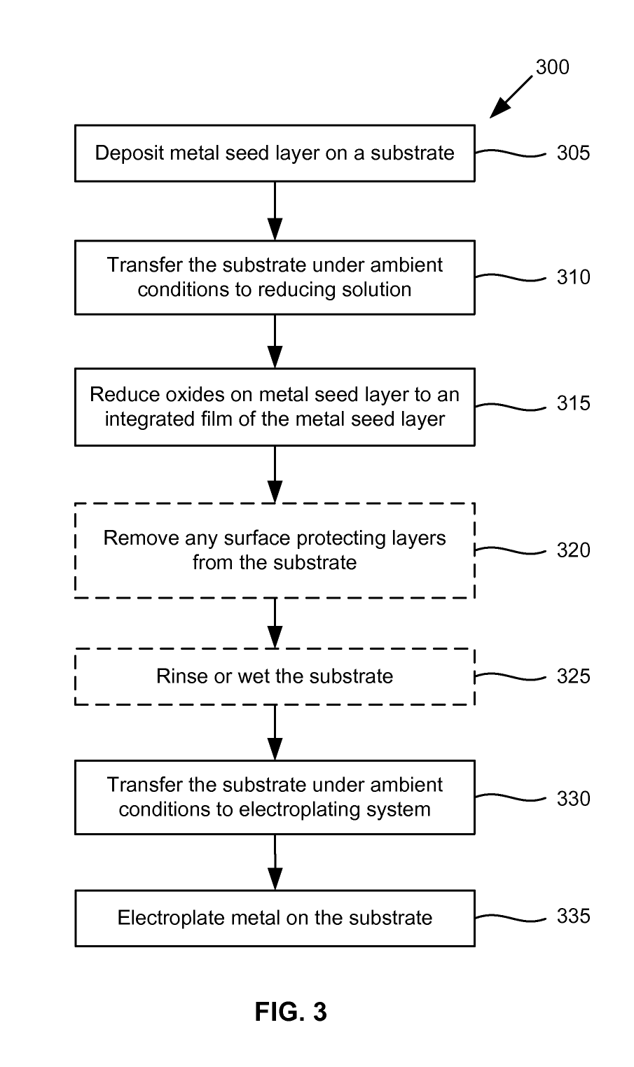

FIG. 3 shows an exemplary flow diagram illustrating a method of reducing oxides on a metal seed layer and plating metal on a substrate. The process 300 can begin with step 305 where a metal seed layer is deposited on a substrate. In some embodiments, metal seed layer can include a semi-noble metal layer. The semi-noble metal layer may be part of a diffusion barrier or serve as the diffusion barrier. The semi-noble metal layer can include a semi-noble metal, such as ruthenium. Aspects of the semi-noble metal layer can be further described in U.S. Pat. No. 7,442,267 (attorney docket no. NOVLP350), U.S. Pat. No. 7,964,506 (attorney docket no. NOVLP272), U.S. Pat. No. 7,799,684 (attorney docket no. NOVLP207), U.S. patent application Ser. No. 11/540,937 (attorney docket no. NOVLP175), U.S. patent application Ser. No. 12/785,205 (attorney docket no. NOVLP272×1), and U.S. patent application Ser. No. 13/367,710 (attorney docket no. NOVLP272×2), each of which is incorporated in its entirety by reference.

Step 305 can occur in a deposition apparatus such as a PVD apparatus. The process 300 can continue with step 310 where the substrate is transferred to a reducing station or apparatus containing a reducing solution. During step 310, the substrate may be exposed to ambient conditions that can cause the surface of the metal seed layer to oxidize.

At step 315, the substrate may be introduced into a reducing station or apparatus containing the reducing solution. The solution can include a reducing agent for reducing the metal oxide to metal, either directly or indirectly. In some embodiments, the reducing agent works by releasing hydrogen gas or protons that then react at the metal oxide surface to generate a pure metallic surface. As demonstrated below, Equation 3 shows an example of a reducing agent releasing hydrogen gas for subsequent reaction with a metal oxide surface. For example, dimethyl amine borane (DMAB) can decompose to form hydrogen gas. Equation 4 shows a general reaction of hydrogen gas reacting with metal oxide to convert to metal.

(CH₃)₂NH:BH₃→(CH₃)₂NBH₂+H₂ Equation 3

xH₂+MOx→M+xH₂O Equation 4

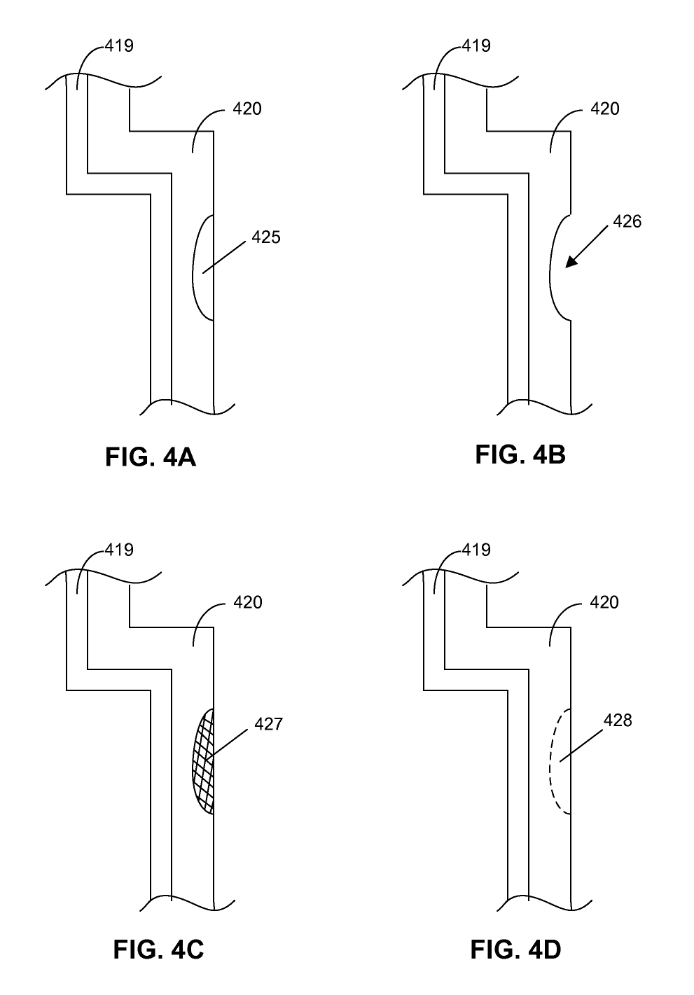

The reducing agent reacts with the metal oxide under conditions that convert the metal oxide to metal in the form of a film integrated with the metal seed layer. Characteristics of the film integrated with the metal seed layer are discussed in further detail with respect to FIG. 4D below.

The reducing agent can comprise a single reducing compound or a mixture of multiple reducing compounds. Exemplary classes of reducing agent compounds can include: boron-containing compounds, nitrogen-containing compounds, and phosphorus-containing compounds. However, it is understood that the reducing agent is not limited to such classes.

In some embodiments, the reducing agent comprises a boron-containing compound. The boron-containing compound can be a borane complex, such as ammonia borane, dimethyl amine borane (DMAB), diethyl amine borane (DEAB), morpholine borane, isopropyl amine borane, and other borane complexes that can readily release hydrogen or protons. In other examples, the boron-containing compound can be a borohydride. The borohydride can comprise various counter ions, such as sodium (Na), potassium (K), lithium (Li), or tetramethylammonium to also reduce the metal oxides.

In some embodiments, the reducing agent comprises a nitrogen-containing compound. The nitrogen-containing compound can be hydrazine, such as pure hydrazine, hydrazine chloride, hydrazine bromide, and hydrazine hydrate.

In some embodiments, the reducing agent comprises a phosphorus-containing compound. The phosphorus-containing compound can be a hypophosphite such as sodium hypophosphite, ammonium hypophosphite, calcium hypophosphite, hypophosphorus acid, and hypophosphite monohydrate.

Other reducing agents can include compounds containing aldehyde functional groups, such as glyoxylic acid and formaldehyde. Further reducing agents can include metallic species, such as titanium (III) ions derived from compounds including titanium (III) chloride and titanium (III) sulfate.

The reducing agent may be dissolved in any suitable solvent system. For example, the reducing agent can be dissolved in water or alcohol (for example, methanol, ethanol, etc.). Other examples can include toluene, methylene chloride, dimethylsulfoxide, etc.

The reducing agent may be dissolved in solution at an appropriate concentration. In some embodiments, the concentration of the reducing agent can be between about 0.001 M and about 5 M. For example, the concentration of the reducing agent can be between about 0.1 M and about 5 M.

In addition, a particular pH may be appropriate depending on the composition of the reducing agent for stabilizing the reducing agent. In some embodiments, the pH of the solution may be between about 7 and about 12. For example, the pH of the solution may be substantially about 7.0, 7.5, 8.0, 8.5, 9.0, 9.5, 10.0, 10.5, 11.0, 11.5, or 12.0.

The reducing agent may react with the metal oxide by contacting a solution containing the reducing agent with the metal seed layer. In some embodiments, the contacting step may be achieved by immersing the substrate in the solution containing the reducing agent. In some embodiments, the contacting step may be achieved by spraying the solution onto the surface of the metal seed layer. In some embodiments, the contacting step may be achieved by exposing the surface of the metal seed layer to a vaporized solution containing the reducing agent.

The duration of the contacting step may vary depending on the properties of the metal oxide, the composition of the reducing agent, the temperature of the reducing solution, and other parameters. In some embodiments, the contacting step may occur from anywhere between about 1 second and about 20 minutes. For example, the duration of the contacting step may be between about 5 seconds and about 5 minutes.

The atmosphere in which the contacting step occurs may be an atmosphere that reduces or limits the effects of reoxidation of the metal seed layer. For example, the atmosphere can be an inert atmosphere, such as an atmosphere substantially comprising nitrogen or argon. In some embodiments, the atmosphere can be a reducing atmosphere, such as an atmosphere containing hydrogen. In some embodiments, the atmosphere can be a mixture of an inert and reducing atmosphere, such as an atmosphere with forming gas (for example, nitrogen and hydrogen).

The temperature of the solution at which the contacting step occurs may be relatively low compared to conventional techniques for reducing metal oxide surfaces, such as hydrogen-based plasma treatments or thermal forming gas anneal. In some embodiments, the temperature can be between about 5° C. and about 300° C., such as between about 10° C. and about 100° C. Higher temperatures may be used to speed up metal oxide reduction reactions to shorten the duration of the contacting step.

The solution containing the reducing agent can have a low concentration of dissolved oxygen to reduce the effects of oxygen reoxidizing the surface of the metal seed layer. In some embodiments, the concentration of dissolved oxygen can be between about 0 ppm and about 10 ppm. The concentration of dissolved oxygen can be reduced by using a nitrogen-sparged solution. In addition, the solution containing the reducing agent can be substantially free of metal ions.

Additives to the reducing agent may provide surface protecting layers to minimize the effects of reoxidation. Optionally at step 320, the surface protecting layers may be removed from the metal seed layer. In some embodiments, removal of the surface protecting layer may occur in the same apparatus or solution as the electroplating bath.

Prior to electroplating, the substrate may optionally be rinsed or wetted at step 325 and then dried. For example, the substrate may be rinsed with de-ionized water. The rinsing of the substrate can substantially remove any reducing agent from the surface of the metal seed layer. The substrate may be transferred to the electroplating system at step 330 thereafter.

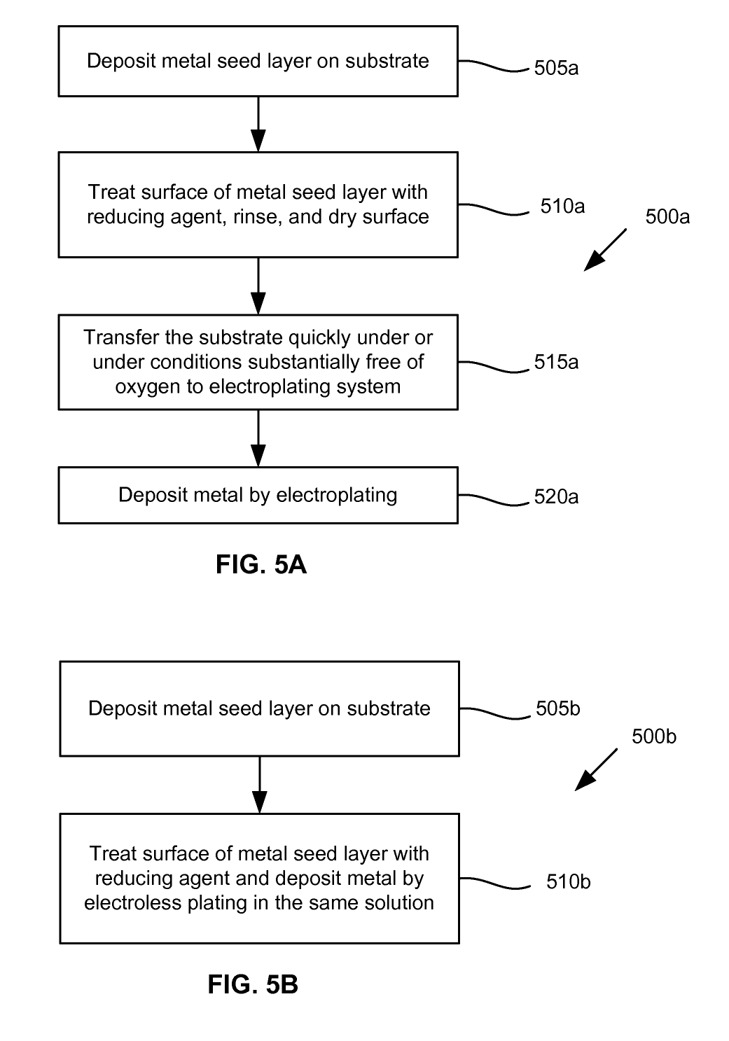

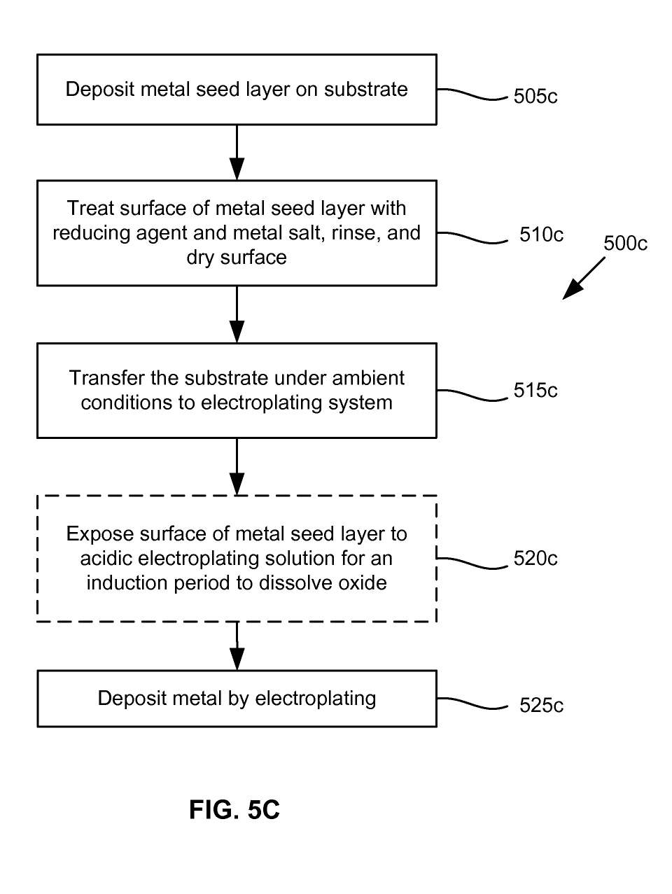

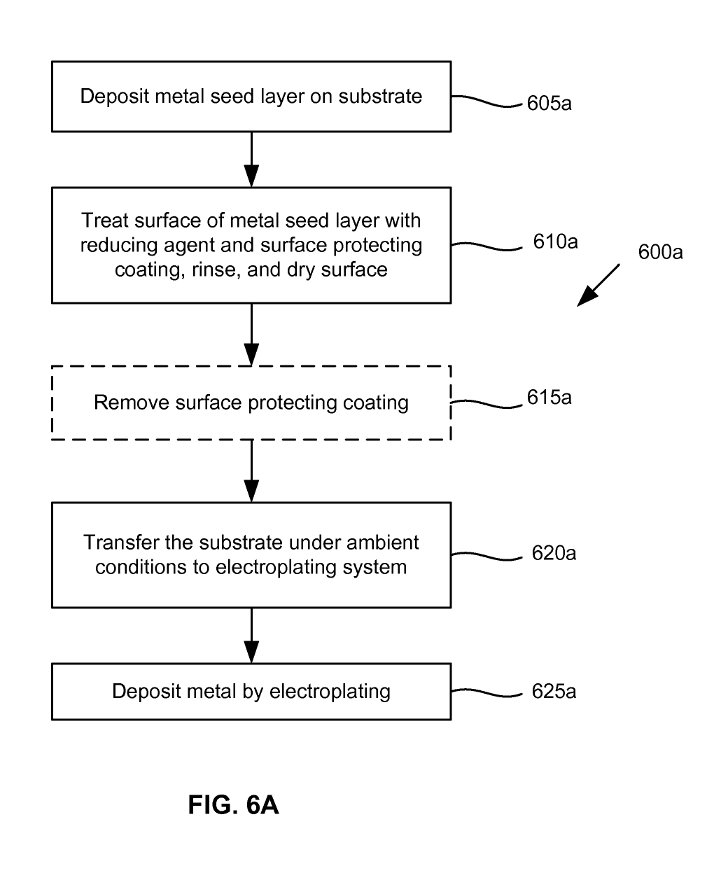

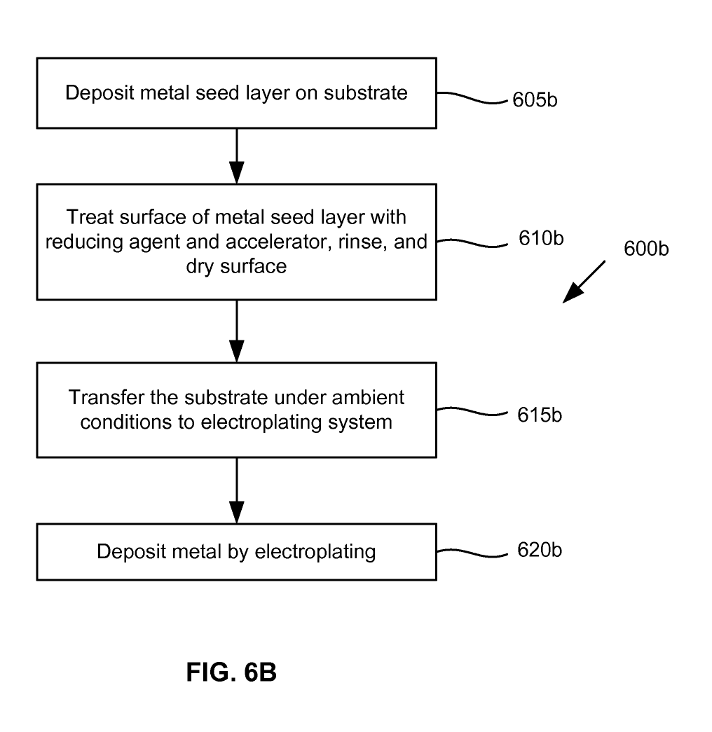

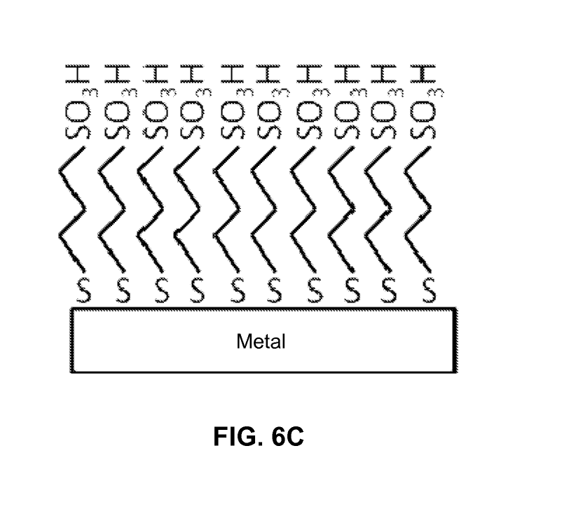

At step 330 in FIG. 3, the substrate may be transferred under ambient conditions to the electroplating system or other pretreating apparatus. Though metal oxides in the metal seed layer have been substantially reduced by contacting the metal oxides with the reducing solution, performing step 330 may present an additional challenge of reoxidation from exposure to the ambient environment. In some embodiments, exposure to ambient conditions may be minimized using techniques such as shortening the duration of transfer, controlling the atmosphere during transfer, or using the same solution for the reducing agent as an electroless plating bath. Examples of such techniques are discussed in further detail with respect to FIGS. 5A-5B. In some embodiments, the reducing agent can include additives that protect the metal seed layer from reoxidation. Examples of such additives are discussed in further detail with respect to FIGS. 5C and 6A-6C. At step 335, metal may be electroplated on to the substrate.

FIGS. 4A-4D show examples of cross-sectional schematics of a metal seed layer deposited on a conductive barrier layer. FIG. 4A shows an example of a cross-sectional schematic of an oxidized metal seed layer deposited over a conductive barrier layer 419. As discussed earlier herein, the metal seed layer 420 may be oxidized upon exposure to oxygen or water vapor in ambient conditions, which can convert metal to a metal oxide 425 in a portion of the metal seed layer 420.

FIG. 4B shows an example of a cross-sectional schematic of a metal seed layer with a void due to removal of metal oxide. As discussed earlier herein, some solutions treat the metal oxide 425 by removal of the metal oxide 425, resulting in voids 426. For example, the metal oxide 425 can be removed by oxide etching or oxide dissolution by an acid or other chemical. Because the thickness of the void 426 can be substantially large relative to the thinness of the metal seed layer 420, the effect of the void 426 on subsequent plating can be significant.

FIG. 4C shows an example of a cross-sectional schematic of a metal seed layer with reduced metal oxide forming a reaction product not integrated with the metal seed layer. As discussed earlier herein, some solutions reduce the metal oxide 425 under conditions that agglomerate metal with the metal seed layer 420. In some embodiments, reducing techniques generate metal particles 427, such as copper powder, that can agglomerate with the metal seed layer 420. The metal particles 427 do not form an integrated film with the metal seed layer 420. Instead, the metal particles 427 are not continuous, conformal, and/or adherent to the metal seed layer 420.

FIG. 4D shows an example of a cross-sectional schematic of a metal seed layer with reduced metal oxide forming a film integrated with the metal seed layer. In some embodiments, a solution with a suitable reducing agent can reduce the metal oxide 425. When process conditions such as temperature, atmosphere, pH, duration, composition of reducing agent, concentration of reducing agent, and concentration of dissolved oxygen are appropriately adjusted, the metal oxide 425 in FIG. 4A may convert to a film 428 integrated with the metal seed layer 420. The film 428 is not a powder. In contrast to the example in FIG. 4C, the film 428 can have several properties that integrate it with the metal seed layer 420. For example, the film 428 can be substantially continuous and conformal over the contours metal seed layer 420. Moreover, the film 428 can be substantially adherent to the metal seed layer 420, such that the film 428 does not easily delaminate from the metal seed layer 420.

There may be several techniques for minimizing the effects of reoxidation from exposure to ambient conditions. Some techniques include shortening the duration of transfer, controlling the atmosphere during transfer, or using the same solution for the reducing agent as an electroless plating bath. Some techniques include combining an additive with the reducing agent to form a surface protecting layer on the metal seed layer to prevent reoxidation

FIG. 5A shows an exemplary flow diagram illustrating a method of reducing metal oxide surfaces and minimizing reoxidation during transfer to an electroplating system. FIG. 5A illustrates a two-step process pathway of first reducing the metal oxide in the metal seed layer and then depositing metal in an electroplating system. In some embodiments, the duration of the transfer may be relatively short to minimize exposure to ambient conditions. For example, the duration of the transfer can be between about 5 seconds and about 1 minute or more. In some embodiments, the exposure to ambient environment during transfer may be minimized by transferring the substrate in an inert or reducing atmosphere.

In some embodiments, the reducing agent may be in solution substantially devoid of dissolved oxygen. For example, the solution may be sparged with nitrogen. Moreover, the entire pretreatment can be done in a nitrogen-sparged environment, including rinsing with nitrogen-sparged deionized water.

FIG. 5B shows an exemplary flow diagram illustrating a method of reducing metal oxide surfaces and minimizing reoxidation by having reducing treatment and electroless deposition occur in the same solution. FIG. 5B illustrates a one-step process pathway for reducing metal oxide in the metal seed layer and electrolessly depositing metal on the metal seed layer using the same solution. Thus, plating the metal on the metal seed layer can be concomitant with reducing metal oxide surfaces. However, it is understood that electroless plating may also be performed in conjunction with transferring the substrate with the metal seed layer to an electroplating bath for bulk deposition of metal onto the metal seed layer. Electroless plating may use an electroless bath containing metal ions, a complexing agent, and a reducing agent to plate metal without the passage of an electric current. In some embodiments, copper can be electrolessly plated for bottom-up fill of copper film on a copper seed layer. The electroless plating process or aspects of the electroless plating process can be described in U.S. Pat. No. 6,962,873 (attorney docket no. NOVLP052), U.S. Pat. No. 6,664,122 (attorney docket no. NOVLP026), U.S. Pat. No. 6,815,349 (attorney docket no. NOVLPO₄₃), and U.S. Pat. No. 7,456,102 (attorney docket no. NOVLP139), each of which is incorporated in its entirety by reference.

In addition to reducing exposure time, controlling the atmosphere of the transfer, and concomitantly having the reducing treatment and the electroless deposition occur in the same solution, additives may be added with the reducing agent in solution to form surface protecting layers to minimize reoxidation. FIG. 5C presents a flow chart of an example of adding a metal salt to provide a surface protecting layer, and FIGS. 6A-6B presents flow charts of examples of adding organic additives to provide surface protecting layers.

An inorganic, surface protecting layer can be formed over the metal seed layer by contacting a solution containing a reducing agent and a soluble metal salt. FIG. 5C shows an exemplary flow diagram illustrating a method comprising treating a surface of a metal seed layer with a reducing agent and a metal salt. The process 500c can begin in step 505c by depositing a metal seed layer on a substrate, followed by step 510c where a surface of the metal seed layer is treated with a solution containing a reducing agent and metal salt. The metal salt is soluble in solution and forms an inorganic, protective sacrificial layer over the metal seed layer to prevent further reoxidation. The solution for treating the metal oxide with the reducing agent and the metal salt is the same. In other words, the same solution first removes metal oxide and then deposits the metal from the metal salt onto the metal seed layer. In effect, this simultaneous treatment with a reducing agent and electroless plating of a metal from a metal salt can be similar to step 510b in FIG. 5B.

In some embodiments, the metal salt can be any cobalt (II) salt, such as cobalt sulfate, cobalt chloride, and cobalt hydroxide. In addition, other metal salts that may form protective sacrificial layers include salts of nickel, tin, and iron. When cobalt sulfate is added to a reducing agent solution, for example, the cobalt can deposit on top of a metal such as copper through an electroless process. The deposited cobalt may rapidly form cobalt oxides on exposure to air, but the underlying metal surface will not form an oxide.

In step 515c, the substrate with a protective sacrificial layer may be transferred to an electroplating system under ambient conditions or stored under ambient conditions. During step 515c, the protective sacrificial layer, such as a layer of cobalt oxide, minimizes reoxidation of underlying metal.

In step 520c, the substrate with the protective sacrificial layer may optionally be exposed to an acidic electroplating solution for an induction period before plating is initiated. The acidic solution dissolves the protective sacrificial layer while leaving the surface of the metal seed layer exposed for subsequent plating. The induction period, which is the period between immersing the substrate in an electroplating bath and current application, can be controlled so as to sufficiently dissolve the sacrificial layer without dissolving the underlying seed layer. The induction period could be between about 0 seconds and about 1 minute, depending on the thickness of the deposited film. An induction period may not be required because the addition of small amounts of the electrolessly deposited inorganic material may be desired for improvement of characteristics, such as electromigration. Following the induction period, bulk metal is plated on the metal seed layer by electroplating in step 525c.

Alternatively, an additive may be added in solution to provide a surface protecting coating over the metal seed layer. FIG. 6A shows an exemplary flow diagram illustrating a method comprising treating a surface of a metal seed layer with a reducing agent and surface protecting coating. The process 600a may begin at step 605a where a metal seed layer is deposited on a substrate. From there, the metal seed layer may be treated with the reducing agent and surface protecting coating in step 610a, followed by a rinsing and drying operation.

The additives to form the surface protecting coating can be organic. In some embodiments, the additives that may be added to form a surface protecting coating with the reducing agent can include sulfur-containing compounds. Sulfur-containing compounds can bond to a metal surface through the formation of a metal-sulfur (M—S) bond. Examples of sulfur-containing compounds that form M—S bonds to protect the surface of a metal seed layer include n-alkane class of thiols (n−2-25) and thiazole.

In some embodiments, the organic additives that may be added to also form a surface protecting coating with the reducing agent can include non-sulfur-containing compounds, such as benzotriazole, 5-methyl-1H-benzotriazole, and benzotriazole-5 carboxylic acid.

Before transferring the substrate and plating the metal seed layer with bulk metal, the surface protecting coating may be removed in step 615a. In some embodiments, the surface protecting coating may be removed by treatment with an acid, heat, or ultraviolet light irradiation, followed by rinsing to break remaining bonds from the surface protecting coating, such as M—S bonds. The substrate with an exposed metallic surface may be transferred to the electroplating system in step 620a, which can then be followed by plating metal onto the metal seed layer in step 625a.

FIG. 6B shows an exemplary flow diagram illustrating a method comprising treating a surface of a metal seed layer with a reducing agent and accelerators. The process 600b begins at step 605b which can be similar to step 605a as described with respect to FIG. 6A. Then in step 610b, the metal seed layer may be treated with the reducing agent and accelerator, followed by a rinsing and drying operation.

As the name implies, accelerators are additives that increase the rate of a plating reaction. Accelerators are molecules that adsorb onto metal surfaces and increase the local current density at a given applied voltage. Typically, accelerators contain pendant sulfur atoms that can form a surface protecting coating through M—S bond formation. Such coatings can protect the surface from reoxidation and also catalyze electrodeposition of metal in electroplating solutions. Accelerators are understood to participate in the cupric ion reduction reaction and strongly influence the nucleation and surface growth of copper films.

While not wishing to be bound by any theory or mechanism of action, it is believed that accelerators (either alone or in combination with other bath additives) tend to locally reduce the polarization effect associated with the presence of suppressors, and thereby locally increase the electrodeposition rate. The reduced polarization effect is most pronounced in regions where the adsorbed accelerator is most concentrated (i.e., the polarization is reduced as a function of the local surface concentration of adsorbed accelerator). Although the accelerator may become strongly adsorbed to the substrate surface, the accelerator is generally not incorporated into the film. Thus, the accelerator remains on the surface as metal is deposited. As a recess is filled, the local accelerator concentration increases on the surface within the recess. Accelerators tend to be relatively small molecules and exhibit relatively fast diffusion into recessed features.

In some embodiments, accelerators can be organic sulfur-containing compounds in different thiol forms with sulfonic acid on one end, for example: X—S—S—C≡C≡C—SO₃—, where X is an alkyl or alkyl sulfonate group. Some accelerator additives are derivatives of mercaptoprop anesulfonic acid (“MPS,” e.g., 3-mercapto-propanesulfonic acid). Other accelerator additives are derivatives of dimercaptopropanesulfonic acid (“DPS”) or bis(3-sulfopropyl) disulfide (“SPS”). Other accelerators include: 2.5-dimercapto-1,3,4-thiadazole (“DMTD”), 5-methyl-2-mercapto-1,3,4-thiadazole (“MMTD”), 5-amino-2-mercapto-1,3,4-thiadazole (“AMTD”), 1-phenyl-1H-tetrazole-5-thiol (“PTT”), 5-mercapto-1-methyltetrazole (“MMT”), and 1-methyl-1H-tetrazole-5-thiol (“MTT”). Some accelerators, alternatively termed brighteners, are described, for example in U.S. Pat. No. 5,252,196, which is incorporated herein by reference. Accelerators are available commercially, for example as Ultrafill A-2001 from Shipley Company (Marlborough, Mass.) or as Viaform Accelerator or SC Primary from Enthone OMI (New Haven, Conn.).

Accelerators need not undergo a removal step in contrast to the surface protecting coating in FIG. 6A, because the accelerators provide an activated surface for catalysis of plating bulk metal. Thus, the metal seed layer treated with the reducing agent and accelerator can proceed directly to steps 615b and 620b, which can be similar to steps 620a and 625a in FIG. 6A, respectively.

FIG. 6C shows a schematic example of accelerator molecules formed on a metal surface. In the example as illustrated in FIG. 6C, a thiol self-assembled monolayer is formed onto a metal surface. The thiol self-assembled monolayer illustrates an accelerator providing a surface protecting coating against further reoxidation and also a surface catalyst to catalyze electrodeposition.

In some embodiments, various additives may be further added to the solution containing the reducing agent to assist in surface wetting and/or stabilizing the reducing agent. For example, additives that can assist in surface wetting include surfactant molecules. Surfactant molecules are available commercially, for example as Triton® and EO/PO block copolymers from the Dow Chemical Company (Midland, Mich.), and Zonyl® from DuPont (Wilmington, Del.). Surfactant molecules can assist in wetting the surface of the metal seed layer so as to allow the reducing agent to more easily coat and reduce the metal oxide surfaces.

In other examples, additives may be added to the solution containing the reducing agent to stabilize the reducing agent and prolong its activity in solution. Typically, the reducing agents described earlier herein can decompose over time and become less effective at converting metal oxides to metal. Additives that can serve as stabilizers for reducing agents include, for example, triazoles, imidazoles, sulfones, and thiazoles. Thus, adding stabilizers in solution can increase the lifetime of reducing agent solutions and reduce the cost of ownership associated with running new process pathways.

It is understood that any of the additives discussed earlier herein may be added to the solution as a mixture of multiple additives to obtain solutions with multiple modes of activity.

### Apparatus

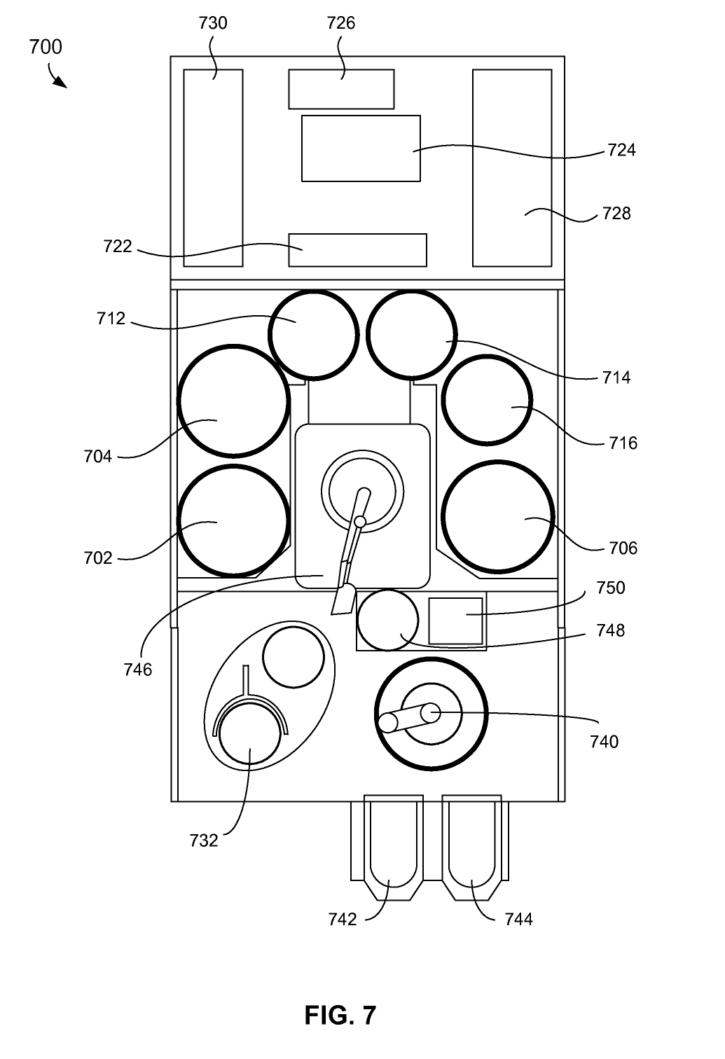

Some of the electrodeposition and reducing treatment methods disclosed herein can be described in reference to, and may be employed in the context of, various integrated tool apparatuses. Electrodeposition, reducing, and other methods disclosed herein can be performed in components that form a larger electrodeposition apparatus. FIG. 7 shows a schematic of a top view of an electrodeposition apparatus. The electrodeposition apparatus 700 can include three separate electroplating modules 702, 704, and 706. The electrodeposition apparatus 700 can also include three separate modules 712, 714, and 716 configured for various process operations. For example, in some embodiments, modules 712 and 716 may be spin rinse drying (SRD) modules and module 714 may be an annealing station. In some embodiments, at least one of the modules 712, 714, and 716 may be modified to include pretreatment for reducing metal oxides. In some embodiments, at least one of the electroplating modules 702, 704, and 706 may be modified to integrate pretreatment for reducing metal oxides with electroplating. In other embodiments, the modules 712, 714, and 716 may be post-electrofill modules (PEMs), each configured to perform a function, such as edge bevel removal, backside etching, and acid cleaning of substrates after they have been processed by one of the electroplating modules 702, 704, and 706.

The electrodeposition apparatus 700 includes a central electrodeposition chamber 724. The central electrodeposition chamber 724 is a chamber that holds the chemical solution used as the electroplating solution in the electroplating modules 702, 704, and 706. The electrodeposition apparatus 700 also includes a dosing system 726 that may store and deliver additives for the electroplating solution. A chemical dilution module 722 may store and mix chemicals to be used as an etchant. A filtration and pumping unit 728 may filter the electroplating solution for the central electrodeposition chamber 724 and pump it to the electroplating modules.

In some embodiments, an annealing station 732 may be used to anneal substrates as a pretreatment. The annealing station 732 may include a number of stacked annealing devices, e.g., five stacked annealing devices. The annealing devices may be arranged in the annealing station 732 one on top of another, in separate stacks, or in other multiple device configurations.

A system controller 730 provides electronic and interface controls required to operate the electrodeposition apparatus 700. The system controller 730 (which may include one or more physical or logical controllers) controls some or all of the properties of the electroplating apparatus 700. The system controller 730 typically includes one or more memory devices and one or more processors. The processor may include a central processing unit (CPU) or computer, analog and/or digital input/output connections, stepper motor controller boards, and other like components. Instructions for implementing appropriate control operations as described herein may be executed on the processor. These instructions may be stored on the memory devices associated with the system controller 730 or they may be provided over a network. In certain embodiments, the system controller 730 executes system control software.

The system control software in the electrodeposition apparatus 700 may include instructions for controlling the timing, mixture of electrolyte components, inlet pressure, plating cell pressure, plating cell temperature, substrate temperature, current and potential applied to the substrate and any other electrodes, substrate position, substrate rotation, and other parameters of a particular process performed by the electrodeposition apparatus 700. System control software may be configured in any suitable way. For example, various process tool component sub-routines or control objects may be written to control operation of the process tool components necessary to carry out various process tool processes. System control software may be coded in any suitable computer readable programming language.

In some embodiments, system control software includes input/output control (IOC) sequencing instructions for controlling the various parameters described above. For example, each phase of an electroplating process may include one or more instructions for execution by the system controller 730. The instructions for setting process conditions for an immersion process phase may be included in a corresponding immersion recipe phase. In some embodiments, the electroplating recipe phases may be sequentially arranged, so that all instructions for an electroplating process phase are executed concurrently with that process phase.

Other computer software and/or programs may be employed in some embodiments. Examples of programs or sections of programs for this purpose include a substrate positioning program, an electrolyte composition control program, a pressure control program, a heater control program, and a potential/current power supply control program.

In some embodiments, there may be a user interface associated with the system controller 730. The user interface may include a display screen, graphical software displays of the apparatus and/or process conditions, and user input devices such as pointing devices, keyboards, touch screens, microphones, etc.

In some embodiments, parameters adjusted by the system controller 730 may relate to process conditions. Non-limiting examples include temperature, duration, composition of gases in the atmosphere, etc. These parameters may be provided to the user in the form of a recipe, which may be entered utilizing the user interface.

Signals for monitoring the process may be provided by analog and/or digital input connections of the system controller 730 from various process tool sensors. The signals for controlling the process may be output on the analog and digital output connections of the process tool. Non-limiting examples of process tool sensors that may be monitored include mass flow controllers, pressure sensors (such as manometers), thermocouples, etc. Appropriately programmed feedback and control algorithms may be used with data from these sensors to maintain process conditions.

In some embodiments, operations in a reducing chamber or pretreatment chamber that is part of an electroplating system are controlled by a computer system. The computer system may include a system controller including program instructions. The program instructions may include instructions to perform all of the operations needed to reduce metal oxides to metal in a metal seed layer in the form of a film integrated with the metal seed layer.

In some embodiments, a system controller (which may include one or more physical or logical controllers) controls some or all of the properties of a process tool. The system controller will typically include one or more memory devices and one or more processors. The processor may include a central processing unit (CPU) or computer, analog and/or digital input/output connections, stepper motor controller boards, and other like components. Instructions for implementing appropriate control operations are executed on the processor. These instructions may be stored on the memory devices associated with the controller or they may be provided over a network. In certain embodiments, the system controller executes system control software.

The system control software may include instructions for controlling the timing, mixture of reducing agents, concentration of reducing agents, chamber pressure, solution temperature, solution pH, mode of contact, mixture of additives, mixture of gases in atmosphere, substrate positioning, and other parameters of a particular process performed by the process tool. System control software may be configured in any suitable way. For example, various process tool component sub-routines or control objects may be written to control operation of the process tool components necessary to carry out various process tool processes. System control software may be coded in any suitable computer readable programming language.

In some embodiments, system control software includes input/output control (IOC) sequencing instructions for controlling the various parameters described above. For example, each phase of the pretreatment or reducing process may include one or more instructions for execution by the system controller. The instructions for setting process conditions for contacting with a solution containing a reducing agent may be included in a corresponding reducing phase recipe. In some embodiments, phases of the reducing recipe may be sequentially arranged, so that all instructions for a reducing process phase are executed concurrently with that process phase.

Other computer software and/or programs may be employed in some embodiments. Examples of programs or sections of programs for this purpose include a timing control program, a substrate positioning program, a contacting mode control program, a reducing agent composition control program, a pressure control program, a heater control program, a pH control program, a solution additive control program, and a gas atmosphere control program.

In some embodiments, there may be a user interface associated with the system controller. The user interface may include a display screen, graphical software displays of the apparatus and/or process conditions, and user input devices such as pointing devices, keyboards, touch screens, microphones, etc.

In some embodiments, parameters adjusted by the system controller may relate to process conditions. Non-limiting examples include composition of reducing agents in solution, concentration of reducing agents in solution, temperature, pressure, pH, duration of contact, composition of additives in solution, concentration of additives in solution, concentration of dissolved oxygen, composition of gases in the atmosphere, etc. These parameters may be provided to the user in the form of a recipe, which may be entered utilizing the user interface.

Signals for monitoring the process may be provided by analog and/or digital input connections of the system controller from various process tool sensors. The signals for controlling the process may be output on the analog and digital output connections of the process tool. Non-limiting examples of process tool sensors that may be monitored include mass flow controllers, pressure sensors (such as manometers), thermocouples, etc. Appropriately programmed feedback and control algorithms may be used with data from these sensors to maintain process conditions.

In one embodiment, the system controller 730 includes instructions for receiving a substrate having a metal seed layer on a plating surface of the substrate and subsequently contacting an oxide of the metal of the metal seed layer with a solution containing a reducing agent under conditions that reduce the oxide of the metal to the metal in the form of a film integrated with the metal seed layer. The solution with the reducing agent may contact the oxide of the metal by immersing the substrate in the solution, by spraying the substrate with the solution, or by exposing the oxide of the metal to a vaporized solution containing the reducing agent. The metal can include copper. The solution containing the reducing agent can further include at least one of an organic additive or a metal salt.

In some embodiments, the system controller 730 may further include instructions for electroplating metal onto the metal seed layer. In some embodiments, the system controller 730 also may include instructions for transferring the substrate to an electroplating bath under an atmosphere substantially free of oxygen.

A hand-off tool 740 may select a substrate from a substrate cassette such as the cassette 742 or the cassette 744. The cassettes 742 or 744 may be front opening unified pods (FOUPs). A FOUP is an enclosure designed to hold substrates securely and safely in a controlled environment and to allow the substrates to be removed for processing or measurement by tools equipped with appropriate load ports and robotic handling systems. The hand-off tool 740 may hold the substrate using a vacuum attachment or some other attaching mechanism.

The hand-off tool 740 may interface with the annealing station 732, the cassettes 742 or 744, a transfer station 750, or an aligner 748. From the transfer station 750, a hand-off tool 746 may gain access to the substrate. The transfer station 750 may be a slot or a position from and to which hand-off tools 740 and 746 may pass substrates without going through the aligner 748. In some embodiments, however, to ensure that a substrate is properly aligned on the hand-off tool 746 for precision delivery to an electroplating module, the hand-off tool 746 may align the substrate with an aligner 748. The hand-off tool 746 may also deliver a substrate to one of the electroplating modules 702, 704, or 706 or to one of the three separate modules 712, 714, and 716 configured for various process operations.

In some embodiments, the module 714 may anneal the substrate with a hot plate resistive electrical heating of the copper containing structure itself. In some embodiments, the module 714 may include an ultraviolet (UV) light source or an infrared (IR) light source to anneal the wafer. In some embodiments, the electrodeposition apparatus 700 may include a device to heat the substrate constantly during plating operations. This might be done through the substrate backside.

An apparatus configured to allow efficient cycling of substrates through sequential plating, rinsing, drying, and annealing process operations may be useful for implementations for use in a manufacturing environment. To accomplish this, the module 712 can be configured as a spin rinse dryer and an annealing chamber. With such a module 712, the substrate would only need to be transported between the electroplating module 704 and the module 312 for the copper plating and annealing operations. Further, in some embodiments, the electrodeposition apparatus 700 may keep the substrate in a vacuum environment, an inert gas atmosphere, or a reducing gas atmosphere to aid in avoiding contamination of the substrate.

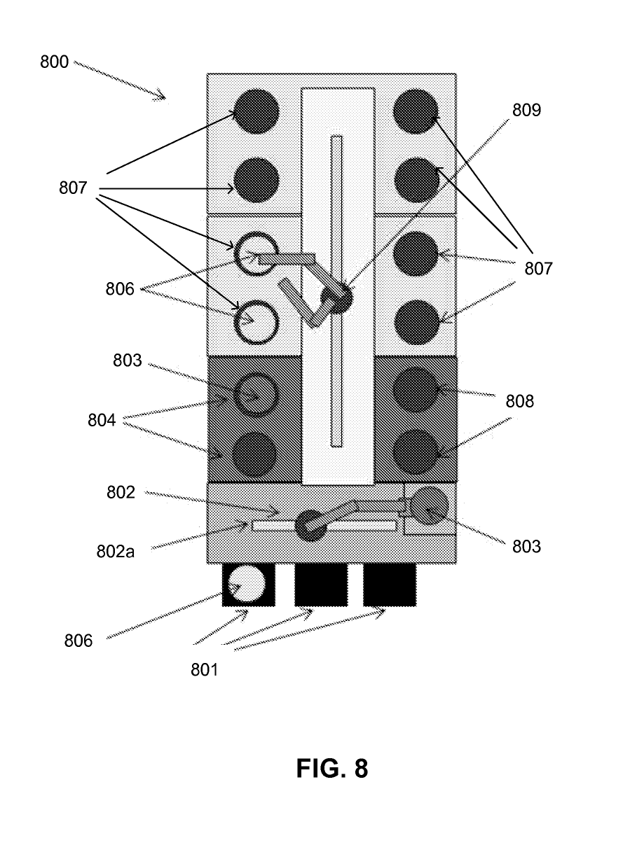

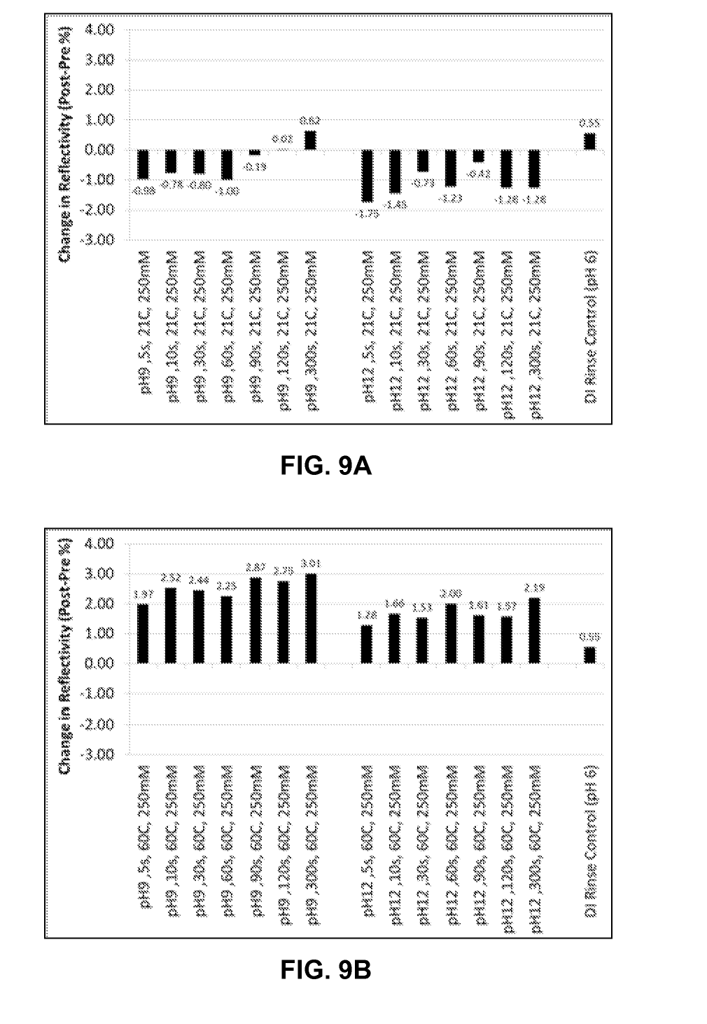

An alternative embodiment of an electrodeposition apparatus 800 is schematically illustrated in FIG. 8. In this embodiment, the electrodeposition apparatus 800 has a set of electroplating cells 807, each containing an electroplating bath, in a paired or multiple “duet” configuration. In addition to electroplating per se, the electrodeposition apparatus 800 may perform a variety of other electroplating related processes and sub-steps, such as spin-rinsing, spin-drying, metal and silicon wet etching, electroless deposition, pre-wetting and pre-chemical treating, reducing, annealing, photoresist stripping, and surface pre-activation, for example. The electrodeposition apparatus 800 is shown schematically looking top down in FIG. 8, and only a single level or “floor” is revealed in the figure, but it is to be readily understood by one having ordinary skill in the art that such an apparatus, e.g. the Novellus Sabre™ 3D tool, can have two or more levels “stacked” on top of each other, each potentially having identical or different types of processing stations.

Referring once again to FIG. 8, the substrates 806 that are to be electroplated are generally fed to the electrodeposition apparatus 800 through a front end loading FOUP 801 and, in this example, are brought from the FOUP to the main substrate processing area of the electrodeposition apparatus 800 via a front-end robot 802 that can retract and move a substrate 806 driven by a spindle 803 in multiple dimensions from one station to another of the accessible stations—two front-end accessible stations 804 and also two front-end accessible stations 808 are shown in this example. The front-end accessible stations 804 and 808 may include, for example, pre-treatment stations, annealing stations, and spin rinse drying (SRD) stations. Lateral movement from side-to-side of the front-end robot 802 is accomplished utilizing robot track 802a. Each of the substrates 806 may be held by a cup/cone assembly (not shown) driven by a spindle 803 connected to a motor (not shown), and the motor may be attached to a mounting bracket 809. Also shown in this example are the four “duets” of electroplating cells 807, for a total of eight electroplating cells 807. The electroplating cells 807 may be used for electroplating copper for the copper containing structure and electroplating solder material for the solder structure. A system controller (not shown) may be coupled to the electrodeposition apparatus 800 to control some or all of the properties of the electrodeposition apparatus 800. The system controller may be programmed or other configured to execute instructions according to processes described earlier herein.

In certain embodiments, the apparatus for contacting the wafer with a reducing agent may be similar or identical to the wafer pre-wetting apparatus as described in U.S. patent application Ser. No. 12/684,787, filed Jan. 8, 2010 (attorney docket no. NOVLP320), and incorporated herein by reference in its entirety. In certain embodiments, the apparatus for contacting the wafer with a reducing agent is similar or identical to accelerator pretreatment apparatus described in U.S. patent application Ser. No. 13/546,146, filed Jul. 11, 2012 (attorney docket no. NOVLP471) and U.S. Pat. No. 7,879,218 issued Feb. 1, 2011 (attorney docket no. NOVLP092), both incorporated herein by reference in their entireties.

The apparatus/process described hereinabove may be used in conjunction with lithographic patterning tools or processes, for example, for the fabrication or manufacture of semiconductor devices, displays, LEDs, photovoltaic panels and the like. Typically, though not necessarily, such tools/processes will be used or conducted together in a common fabrication facility. Lithographic patterning of a film typically includes some or all of the following operations, each operation enabled with a number of possible tools: (1) application of photoresist on a workpiece, i.e., substrate, using a spin-on or spray-on tool; (2) curing of photoresist using a hot plate or furnace or UV curing tool; (3) exposing the photoresist to visible or UV or x-ray light with a tool such as a wafer stepper; (4) developing the resist so as to selectively remove resist and thereby pattern it using a tool such as a wet bench; (5) transferring the resist pattern into an underlying film or workpiece by using a dry or plasma-assisted etching tool; and (6) removing the resist using a tool such as an RF or microwave plasma resist stripper.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

### Data

Solutions containing a reducing agent under various conditions contacted samples of copper seeded trench coupons to determine the effectiveness of the solutions in reducing copper oxide and avoiding void formation. Each of the samples of the copper seeded trench coupons had trenches with a width of about 48 nm each. Optimized copper seeded trench coupons utilized samples where the seed condition provided excellent fill. Marginal copper seeded trench coupons utilized samples where the seed condition provided thin seed coverage. The marginal copper seeded trench coupons generally result in very large bottom voids. The marginal copper seeded trench coupons represent extreme samples that are typically not found on production wafers, but can more effectively indicate the ability of reducing agent treatment in reducing copper oxide and preventing void formation.

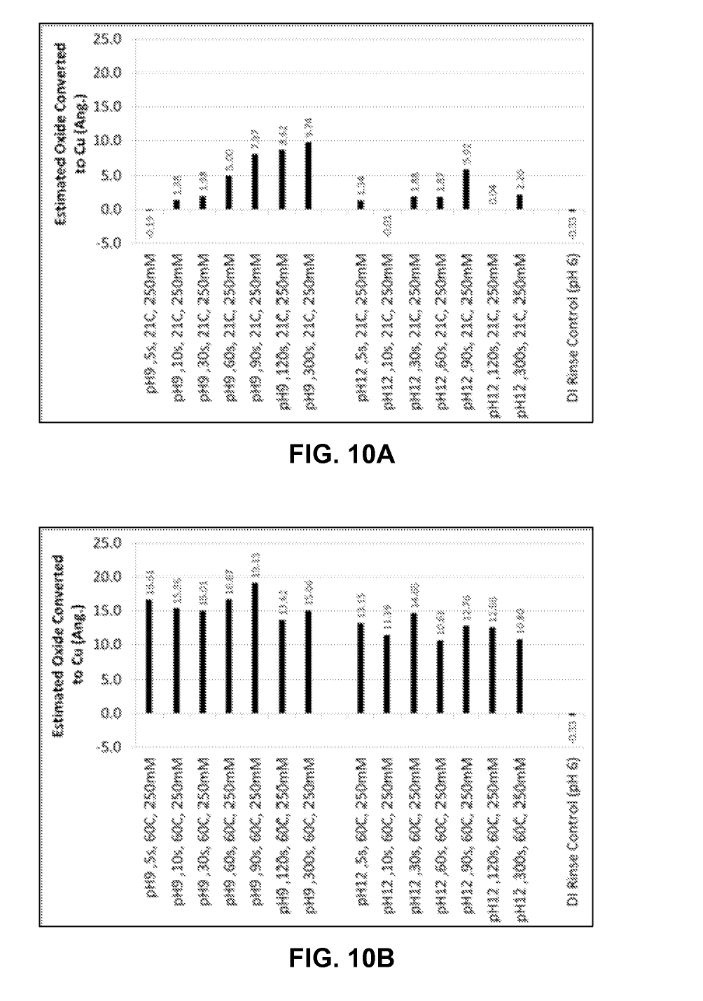

FIGS. 9A and 9B show graphs illustrating the effects of pH, temperature, and exposure time of reducing agent treatment with the change in reflectivity of copper. The higher the reflectivity of the copper sample, the greater the presence of converted pure copper from copper oxide. Here, the samples observed were blanket copper seeded wafers. In the samples in FIGS. 9A and 9B, a solution containing 0.25 M of DMAB reducing agent contacted the blanket copper seeded wafers. In FIG. 9A, the solution was at ambient temperature (e.g., about 21° C.). In FIG. 9B, the solution was at an elevated temperature (e.g., about 60° C.). The length of time of the reducing treatment varied between 5 seconds and 5 minutes. Some of the solution samples had a pH of 9 while the other solution samples had pH of 12. In addition, a de-ionized rinse control is provided for comparison as each of the samples was subject to rinse before exposure to DMAB.

FIGS. 10A and 10B show graphs illustrating the effects of pH, temperature, and exposure time of reducing agent treatment with the estimated copper oxide converted to pure copper. FIGS. 10A and 10B take the results from each of the conditions in FIGS. 9A and 9B, and calculate the estimated amount of copper oxide converted to metallic copper based on surface resistance measurements.

FIGS. 9A and 10A illustrate that at ambient temperature, longer duration of reducing treatment converted more copper oxide to copper at pH of 9. At pH of 12, the reducing treatment was not effective in reducing copper oxide. FIGS. 9B and 10B illustrate that at elevated temperatures, even more copper oxide converted to copper at pH of 9 as well as at pH of 12 compared to ambient temperature. Regardless, a pH of 9 converted more copper oxide to copper than a pH of 12. Furthermore, longer treatment time and an elevated temperature led to greater amounts of copper reduction to copper.

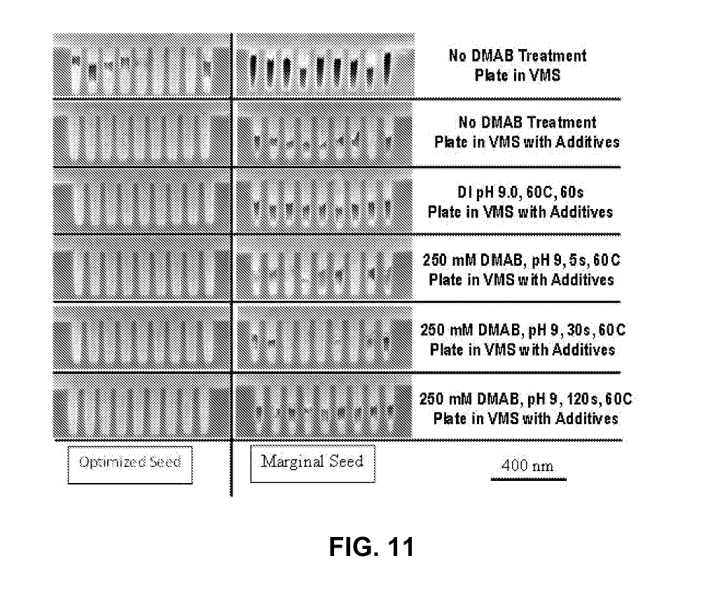

FIG. 11 shows scanning electron microscopy (SEM) images of optimized and marginal seed trench coupons from various treatments illustrating the presence of voids. Some of the treatments were carried out using pH of 9 and 0.25 M DMAB solutions that were heated to 60° C. Some of the treatments were carried out using various control conditions. Representative scanning electron microscopy (SEM) cross section images were taken for each of the conditions.

The first control condition plated copper without any DMAB treatment, which resulted in poor fill almost entirely through each of the trench coupons. Copper plating occurred in virgin makeup solution (VMS) substantially free of organic additives. The second control condition plated copper without any DMAB treatment, but included additives in an electroplating solution that promoted bottom up filling. The third control condition plated copper without any DMAB treatment, but included a de-ionized rinse at pH of 9 before plating in an electroplating solution that had additives for bottom up filling. The third control condition resulted in larger voids than the second control condition, likely due in part to the alkaline solution increasing the oxidation of the copper seed layer.

The fourth, fifth, and sixth conditions plated copper with DMAB treatment at pH of 9 using 0.25 M DMAB solutions that were heated to 60° C., and with electroplating solutions containing additives that promoted bottom up filling. Each of the samples that plated copper under such conditions showed void sizes that were reduced slightly or reduced significantly compared to samples that did not use DMAB, if the void sizes did not remain relatively the same. For treatments with DMAB and for treatment times of up to 90 seconds, the bottom void sizes were appreciably smaller than treatments without DMAB. However, increasing the treatment time beyond 90 seconds appeared to result in an increase in the bottom void size, which may be due in part to reoxidation to solutions and rinse solutions that contain dissolved oxygen.

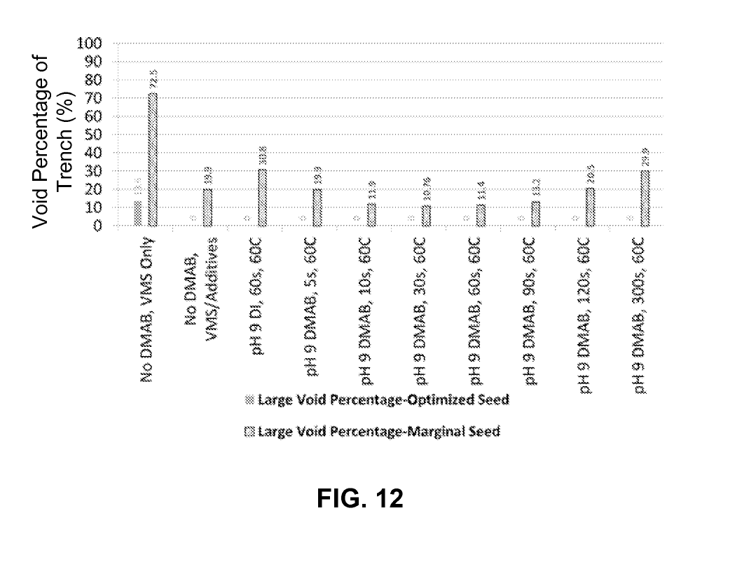

FIG. 12 shows a graph illustrating the percentage of large voids from the various treatments in the optimized and marginal seed trench coupons from FIG. 11. The calculated percentage of large voids taken from the samples in FIG. 11 confirms what is seen in the SEM images in FIG. 11.

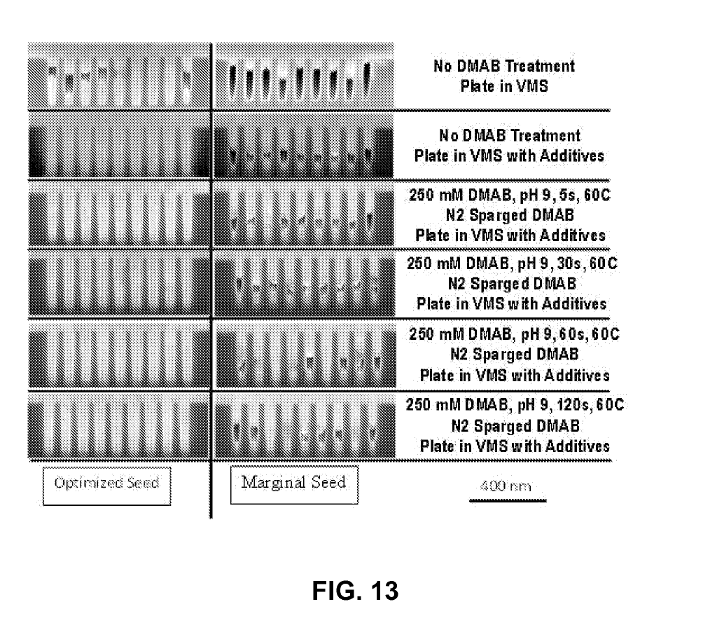

FIG. 13 shows SEM images of optimized and marginal seed trench coupons from various treatments with sparged nitrogen illustrating the presence of voids. Similar to the samples in FIG. 11, some of the treatments were carried out using pH of 9 and 0.25 M DMAB solutions that were heated to 60° C., and some of the treatments were carried out using various control conditions. However, the samples with DMAB treatment also included nitrogen-sparged solutions. The nitrogen-sparged solutions reduce the amount of oxygen in the reducing solution so that the concentration of dissolved oxygen would be very low. Representative scanning electron microscopy (SEM) cross section images were taken for each of the conditions.

The first control condition resulted in very poor fill, while the second control condition resulted improved the fill with additives for promoting bottom up filling. DMAB treatment with nitrogen-sparged solutions reduced the bottom void sizes at 5 seconds, 30 seconds, 60 seconds, and 120 seconds. Thus, regardless of the duration of DMAB treatment, the bottom void sizes were relatively the same. Seed reoxidation over time may have been limited by the nitrogen-sparged solutions.

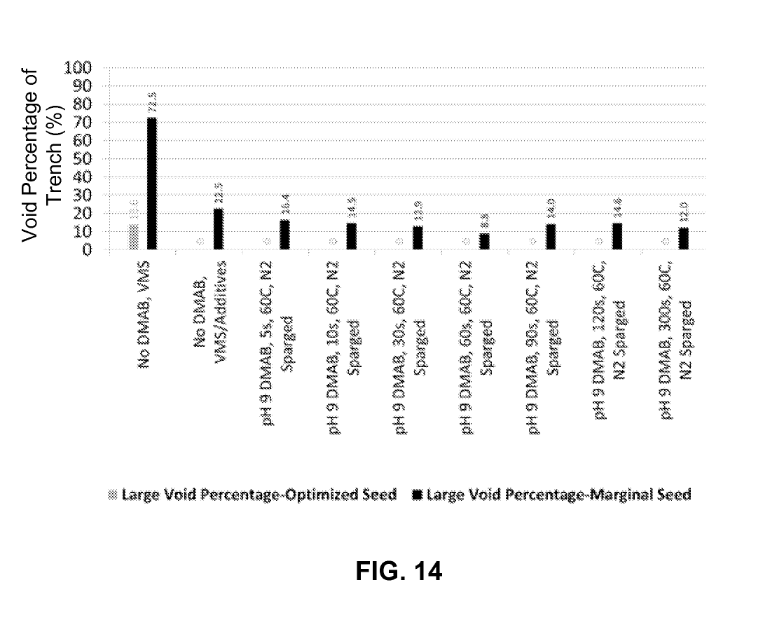

FIG. 14 shows a graph illustrating the percentage of large voids from the various treatments with sparged nitrogen in the optimized and marginal seed trench coupons in FIG. 13. The calculated percentage of large voids taken from the samples in FIG. 13 confirms what is seen in the SEM images in FIG. 13.

### Other Embodiments

Although the foregoing has been described in some detail for purposes of clarity and understanding, it will be apparent that certain changes and modifications may be practiced within the scope of the appended claims. It should be noted that there are many alternative ways of implementing the processes, systems, and apparatus described. Accordingly, the described embodiments are to be considered as illustrative and not restrictive.

1. A method of preparing substrate with a al seed layer for platting, the method comprising:
receiving a substrate having the metal seed layer on a plating surface of the substrate, wherein a portion of the metal seed layer has been converted to an oxide of the metal;
contacting at least the oxide of the metal with a solution containing a reducing agent under conditions that reduce the oxide of the metal to the metal in the form of a film integrated with the seed layer;
transferring the substrate to a plating bath containing a plating solution; and
plating metal onto the metal seed layer using the plating solution.

2. The method of claim 1, wherein the metal comprises copper.

3. The method of claim 1, wherein the average thickness of the metal seed layer is less than about 100 Å.

4. The method of claim 1, wherein the metal seed layer includes a semi-noble metal that serves as a diffusion barrier.

5. The method of claim 1, wherein the reducing agent comprises a boron-containing compound.

6. The method of claim 5, wherein the boron-containing compound is a borane complex selected from the group consisting of: ammonia borane, dimethyl amine borane (DMAB), diethyl amine borane (DEAB), morpholine borane, and isopropyl amine borane.

7. The method of claim 5, wherein the boron-containing compound is a borohydride.

8. The method of claim 1, wherein the reducing agent comprises a nitrogen-containing compound.

9. The method of claim 8, wherein the nitrogen-containing compound is a hydrazine compound selected from the group consisting of: hydrazine, hydrazine chloride, hydrazine bromide, and hydrazine hydrate.

10. The method of claim 1, wherein the reducing agent comprises a phosphorus-containing compound.

11. The method of claim 10, wherein the phosphorus-containing compound is a hypophosphite compound selected from the group consisting of: sodium hypophosphite, calcium hypophosphite, hypophosphorus acid, and hypophosphite monohydrate.

12. The method of claim 1, wherein the contacting step is performed in an inert atmosphere.

13. The method of claim 1, herein the contacting step is performed a reducing gas atmosphere.

14. The method of claim 1, wherein the contacting step is performed at a temperature between about 10° C. and about 100° C.

15. The method of claim 1, wherein the solution containing the reducing agent has a between about 7 and about 12.

16. The method of claim 1, wherein the concentration of the solution containing the reducing agent is between about 0.1 M and about 5 M.

17. The method of claim 1, wherein the concentration of dissolved oxygen in the solution containing the reducing agent is between about 0 ppm and about 10 ppm.

18. The method of claim 1, wherein the solution containing the reducing agent further comprises an additive, wherein the additive forms a surface protecting coating on the metal seed layer.

19. The method of claim 18, further comprising removing the surface protecting coating using at least one of an acid, heat, or ultraviolet light treatment.

20. The method of claim 18, wherein the additive comprises accelerators.

21. The method of claim 1, wherein the solution containing the reducing agent further comprises an additive, wherein the additive increases the wetting potential of the surface of the metal seed layer.

22. The method of claim 1, wherein the solution containing the reducing agent further comprises an additive, wherein the additive increases the stability of the reducing agent.

23. The method of claim 1, wherein the solution containing the reducing agent further comprises a metal salt, wherein the metal salt forms a protective sacrificial layer over the metal seed layer.

24. The method of claim 23, further comprising removing the protective sacrificial layer using an acid.

25. The method of claim 1, wherein the contacting step and the plating metal step occur in the same solution, wherein the plating metal step comprises electrolessly plating metal.

26. The method of claim 1, wherein the substrate is maintained under an atmosphere substantially free of oxygen while transferring the substrate to the plating bath.

27. The method of claim 1, further comprising rinsing the substrate prior to transferring the substrate to substantially remove the reducing agent from the surface of the metal seed layer.

28. The method of claim 1, wherein the solution containing the reducing agent is substantially free of metal ions.

29. An apparatus for preparing a substrate with a metal seed layer for plating, the apparatus comprising a controller with instructions for performing the following operations:
(a) receiving a substrate having the metal seed layer on a plating surface of the substrate, wherein a portion of the metal seed layer has been converted to an oxide of the metal;
(b) contacting at least the oxide of the metal with a solution containing a reducing agent under conditions that reduce the oxide of the metal to the metal in the form of a film integrated with the seed layer;
(c) transferring the substrate to a plating bath containing a plating solution; and
(d) plating metal onto the metal seed layer using the plating solution.

30. The apparatus of claim 29, wherein operation (b) comprises immersing the substrate in the solution containing the reducing agent.

31. The apparatus of claim 29, wherein operation (b) comprises spraying the substrate with the solution containing the reducing agent.

32. The apparatus of claim 29, wherein the metal comprises copper.

33. The apparatus of claim 29, wherein operation (c) is performed in an atmosphere substantially free of oxygen.

34. The apparatus of claim 29, wherein the solution containing the reducing agent is substantially free of metal ions.

35. The apparatus of claim 29, wherein the solution containing the reducing agent further comprises at least one of an organic additive or a metal salt.

36. The method of claim 1, wherein the plating surface of the substrate comprises recesses having height to width aspect ratios of greater than about 5:1.

37. The apparatus of claim 29, wherein the plating surface of the substrate comprises recesses having height to width aspect ratios of greater than about 5:1.
